(19) United States
(12) Patent Application Publication
(10) Pub. No.: US 2026/0100438 A1
(43) Pub. Date: Apr. 9, 2026

(54) SECONDARY BATTERY

(71) Applicant: SAMSUNG SDI CO., LTD., Yongin-si (KR)

(72) Inventors: Dong Hyun KIM, Yongin-si (KR); Ye Jin SEO, Yongin-si (KR); Eun Jeong MOON, Yongin-si (KR)

(21) Appl. No.: 19/186,951

(22) Filed: Apr. 23, 2025

(30) Foreign Application Priority Data
Oct. 4, 2024 (KR) 10-2024-0134596

(51) Int. Cl. H01M 10/6551; H01M 10/613; H01M 50/533; H01M 50/534

(52) U.S. Cl. CPC H01M 10/6551; H01M 10/613; H01M 50/533; H01M 50/534

(57) ABSTRACT

A secondary battery, includes a case having an accommodation part and a cap part, an electrode assembly having a current collector in the accommodation part, an electrode tab in the accommodation part, the electrode tab being connected to the electrode assembly, a lead connected to the electrode tab, and a heat dissipation layer on the electrode tab, the electrode tab including at least two bending regions and a non-bending region, the heat dissipation layer on the at least two bending regions and the non-bending region, and a width of the electrode tab is 25% to 45% of a width of a current collector of the electrode assembly.

### CROSS-REFERENCE TO THE RELATED APPLICATION

The present application claims priority to and the benefit of Korean Patent Application No. 10-2024-0134596, filed on October 4, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments include a secondary battery, including a case including an accommodation part and a cap part, an electrode assembly having a current collector in the accommodation part, an electrode tab in the accommodation part, the electrode tab being connected to the electrode assembly, a lead connected to the electrode tab, and a heat dissipation layer on the electrode tab, the electrode tab including at least two bending regions and a non-bending region, the heat dissipation layer on the at least two bending regions and the non-bending region, and a width of the electrode tab is 25% to 45% of a width of the current collector of the electrode assembly.

The electrode assembly may include a plurality of first electrodes, a plurality of second electrodes, and a separator between each of the plurality of first electrodes and each of the plurality of second electrodes, and the plurality of first electrodes and the plurality of second electrodes may each comprise the current collector and an active material layer on the current collector.

Each of the plurality of first electrodes may include a first current collector and a first active material layer on the first current collector, each of the plurality of second electrodes may include a second current collector and a second active material layer on the second current collector, the electrode tab may include a first electrode tab connected to the first current collector and a second current collector connected to the second current collector, and the heat dissipation layer is on at least one of the first electrode tab and the second electrode tab.

A thickness of the heat dissipation layer may be greater than or equal to a thickness of the current collector and equal to or less than a thickness of an active material layer.

The electrode tab may include a first region, a second region, and a third region, the first region may include adjacent other electrode tabs that are separated, the second region may include adjacent other electrode tabs that are coupled, the third region may be coupled with the lead, and the at least two bending regions may be on at least one of the second region and one the third region.

The heat dissipation layer may be on at least one of the second region and the third region.

The heat dissipation layer may be on at least one surface of the electrode tab.

The heat dissipation layer may include an upper heat dissipation layer on an upper surface of the electrode tab and a lower heat dissipation layer on a lower surface of the electrode tab, and wherein a length of the upper heat dissipation layer and a length of the lower heat dissipation layer may be different.

The lead may be on the upper surface of the electrode tab, the length of the lower heat dissipation layer may be longer than the length of the upper heat dissipation layer, and the lower heat dissipation layer and the lead may overlap.

The electrode tab may include a first electrode tab, a second electrode tab, and a third electrode tab, the first electrode tab may be an upper electrode tab, the second electrode tab may be a lower electrode tab, the third electrode tab may be a middle electrode tab, and the heat dissipation layer may be on at least one of the first electrode tab, the second electrode tab, and the third electrode tab.

The heat dissipation layer may be on at least one of the first electrode tab and the second electrode tab.

The heat dissipation layer may include a first heat dissipation layer on the first electrode tab and a second heat dissipation layer on the second electrode tab, wherein a length of the first heat dissipation layer and a length of the second heat dissipation layer may be different.

The heat dissipation layer may include a first heat dissipation layer on the first electrode tab, a second heat dissipation layer on the second electrode tab, and a third heat dissipation layer on the third electrode tab, wherein a length of the first heat dissipation layer may be different from a length of each of the second heat dissipation layer and the third heat dissipation layer.

The thickness of the third heat dissipation layer may be less than a thickness of the first heat dissipation layer and the thickness of the second heat dissipation layer.

The third electrode tab may include a plurality of electrode tabs, and the third heat dissipation layer is on at least one of the plurality of electrode tabs.

The heat dissipation layer may include the heat dissipation layer on the electrode tab and the heat dissipation layer on the lead.

The heat dissipation layer may surround the electrode tab.

The heat dissipation layer may include a first heat dissipation layer surrounding the first electrode tab and a second heat dissipation layer surrounding a second electrode tab.

The first heat dissipation layer and the second heat dissipation layer may be spaced apart from each other.

The first heat dissipation layer and the second heat dissipation layer may be in contact.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings.

Features will become apparent to those of skill in the art by describing in detail exemplary embodiments with reference to the attached drawings, in which:

FIG. 1 is a perspective view showing a secondary battery according to one or more embodiments;

FIG. 2 is a view explaining a connection of an electrode tab and the lead of the secondary battery of FIG. 1;

FIGS. 3 and 4 are views explaining the bending of the electrode tab of the secondary battery of FIG. 1;

FIGS. 5(a) to 5(i) are views explaining the bending process of the electrode tab of the secondary battery according to the embodiment of FIGS. 1-4;

FIGS. 6(a) and 6(b) are top view of the electrode plates of the secondary battery according to the embodiment of FIGS. 1-5;

FIGS. 7 to 9 are views explaining the arrangement of the heat dissipation layer of the secondary battery according to the embodiment of FIGS. 1-6;

FIG. 10 is a partial side view of the secondary battery according to the embodiment of FIGS. 1-9.

FIGS. 11 to 19 are views explaining the arrangement of the heat dissipation layer of the secondary battery according to one or more other embodiments.

FIGS. 20 and 21 are perspective views showing a battery pack including battery modules according to some embodiments.

FIGS. 22 and 23 are perspective views and a side view showing a vehicle including battery packs according to some embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

Hereinafter, a secondary battery according to one or more embodiments will be described with reference to the drawings. The secondary battery may be classified into a cylindrical shape, a prismatic shape, a pouch shape, or a coin shape depending on the shape. The secondary battery described below may be applied to a pouch-type secondary battery

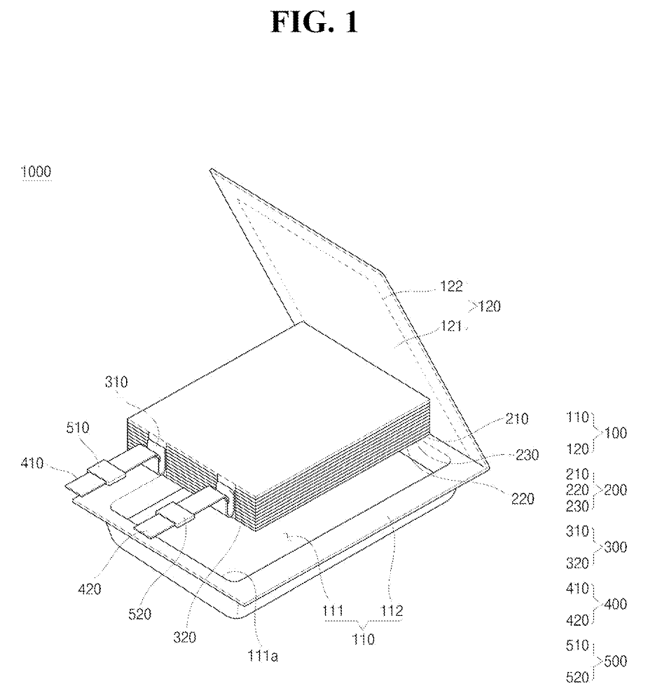

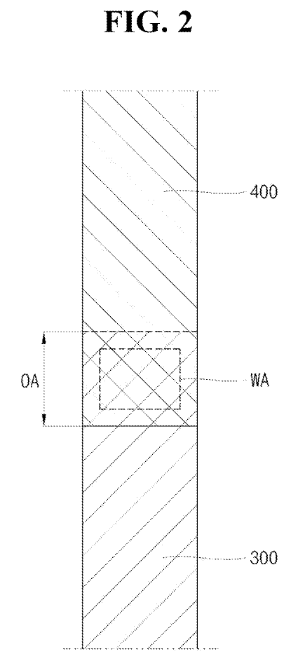

Referring to FIGS. 1 and 2, the secondary battery 1000 according to the embodiment may include a case 100 and an electrode assembly 200.

The case 100 may include an accommodation part 110 and a cap part 120. The accommodation part 110 and the cap part 120 may be connected. The case 100 may be formed in a pouch shape.

The accommodation part 110 may include a concave part 111 and a first sealing region 112. The accommodation part 110 may include an accommodation space. In detail, the accommodation part 110 may include an internal bottom surface and an inner side surface formed by the concave part 111. The accommodation space may be formed by the bottom surface and the inner side surface.

The first sealing region 112 may be disposed at the edge of the accommodation part 110. A sealing layer may be disposed on the first sealing region 112.

The cap part 120 may include a cover part 121 and a second sealing region 122.

The cover part 121 may cover the accommodation part 110. In detail, the cover part 121 may cover the electrode assembly 200 accommodated in the accommodation part 110.

The second sealing region 122 may be disposed at the edge of the cap part 120. The sealing layer may be disposed on the second sealing region 122. The first sealing region 112 and the second sealing region 122 may overlap. In detail, when the accommodation part 110 is covered by the cap part 120, the first sealing region 112 and the second sealing region 122 may face each other. Therefore, the accommodation part 110 and the cap part 120 may be coupled by the sealing layer.

The electrode assembly 200 may be accommodated in the case 100. In detail, the electrode assembly 200 may be accommodated inside the accommodation space of the case. In detail, the electrode assembly 200 may be accommodated inside the accommodation space together with the electrolyte.

In the drawing, one electrode assembly is accommodated in the case. However, two or more electrode assemblies may be accommodated in the case.

The electrode assembly 200 may include a first electrode 210, a second electrode 220, and a separator 230 therebetween. The electrode assembly 200 may be formed by winding or laminating the first electrode 210, the second electrode 220, and the separator 230. In other embodiments, the electrode assembly may be a Z-stack electrode assembly in which the first electrode 210 and the second electrode 220 are inserted on both sides of a separator 230 bent into a Z-stack.

The first electrode 210 may include a first current collector and a first active material layer formed on the first current collector. The first current collector may include a metal foil such as aluminum or an aluminum alloy. The first active material layer may include a transition metal oxide. For example, the first electrode 210 may be a positive electrode.

The first electrode 210 may be connected to a first electrode tab 310. The first active material layer is not disposed on the first electrode tab 310. The first electrode tab 310 may be welded to the first current collector. In other embodiments, the first electrode tab 310 may be formed integrally with the first current collector. For example, the first collector may include a first uncoated portion on which the first active material layer is not disposed. The first uncoated portion may be the first electrode tab 310. The first electrode tab 310 may include the same material as the first current collector.

The second electrode 220 may include a second current collector and a second active material layer formed on the second current collector. The second current collector may include a metal foil such as copper, a copper alloy, nickel, or a nickel alloy. The second active material layer may include graphite or carbon. For example, the second electrode 220 may be a negative electrode.

The second electrode 220 may be connected to a second electrode tab 320. The second active material layer is not disposed on the second electrode tab 320. The second electrode tab 320 may be welded to the second current collector. In other embodiments, the second electrode tab 320 may be formed integrally with the second current collector. For example, the second collector may include a second uncoated portion on which the second active material layer is not disposed. The second uncoated portion may be the second electrode tab 320. The second electrode tab 320 may include the same material as the second current collector.

The first electrode tab 310 and the second electrode tab 320 may each be connected to a lead. For example, the first electrode tab 310 may be connected to the first lead 410. The first electrode tab 310 may be connected to the first external terminal by the first lead 410. The second electrode tab 320 may be connected to the second lead 420. The second electrode tab 320 may be connected to the second external terminal by the second lead 420. The first lead 410 may include the same material as the first electrode tab and the second lead 420 may include the same material as the second electrode tab.

Referring to FIG. 2, the electrode tab 300 and the lead 400 may be coupled by welding.

For example, the electrode tab 300 and the lead 400 may overlap. Accordingly, the electrode tab 300 and the lead 400 may form an overlapping region OA. For example, the lead 400 may be disposed on at least one of one surface or the other surface of the electrode tab 300.

The overlapping region OA may include a welding region WA. The welding region WA may be smaller than the overlapping region OA. The electrode tab 300 and the lead 400 may be welded in the welding region WA. Accordingly, the electrode tab 300 and the lead 400 may be coupled.

An insulating layer 500 may be disposed on the lead. For example, a first insulating layer 510 (see FIG. 1) may be disposed on the first lead 410. A second insulating layer 520 may be disposed on the second lead 420. The lead 400 may be insulated from the case 100 by the insulating layer 500.

Referring to FIGS. 3 to 5, the electrode tab 300 may be bent.

Referring to FIG. 3, the electrode tab 300 may be divided into a plurality of regions. For example, the electrode tab 300 may include a first region 1A, a second region 2A, and a third region 3A. The first region first is a region where the electrode tabs of adjacent electrodes are separated. The second region 2A is a region where the electrode tabs of adjacent electrodes are coupled. The third region 3A is a region where the lead 400 is coupled.

Accordingly, the electrode tab 300 may have a first length L1. The first length L1 may be the sum of the lengths of the first region 1A, the second region 2A, and the third region 3A. That is, the first length L1 may be the length of the electrode tab before bending.

The electrode tab 300 may be bent at least twice. In detail, at least one of the second region 2A or the third region 3A may be bent. In detail, at least two bending regions are on the second region 2A. Accordingly, the length of the electrode tab 300 may be reduced.

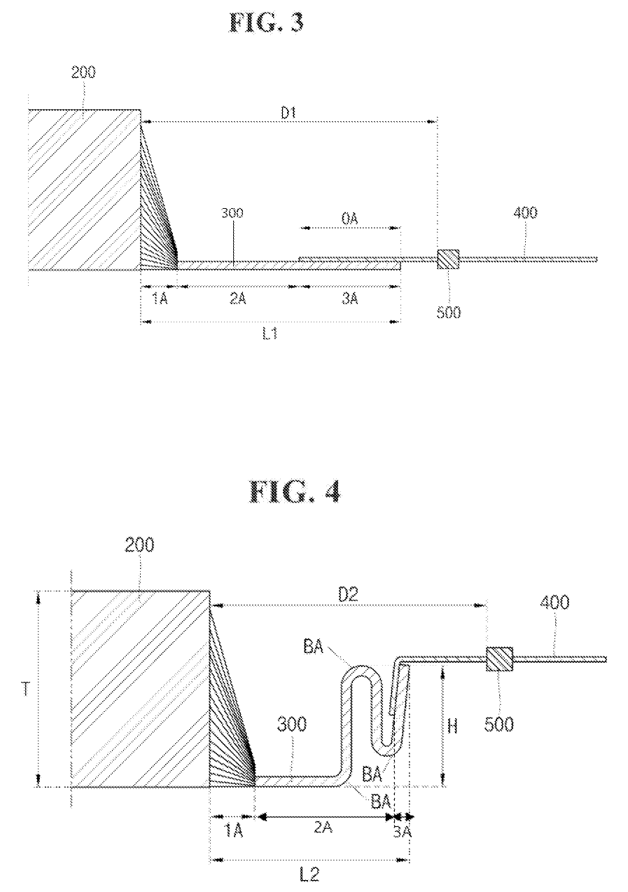

Referring to FIG. 4, the electrode tab 300 may include a plurality of bending regions BA. Although three bending regions are illustrated in the drawing, the number of bending regions may vary.

The length of the electrode tab 300 may be reduced by the bending regions BA. In detail, the lengths of the second region 2A and the third region 3A may be reduced. Therefore, the electrode tab 300 may have a second length L2 after bending. The second length L2 may be the sum of the lengths of the first region 1A, the second region 2A and the third region 3A after bending. That is, the second length L2 may be the length of the electrode tab after bending. In one example, there may be one bending region on each of the second and third regions. In another example, there may be two bending regions on the second region and none on the third region. In still another example, there may be two bending regions on the second region and two bending regions on the third region.

Therefore, the gap between the electrode assembly 200 and the insulating layer 500 may be reduced. That is, the electrode tab 300 has the first length L1 before the electrode tab 300 is bent. Therefore, a first gap D1 between the electrode assembly 200 and the insulating layer 500 increases (e.g., is greater than after bending). However, the electrode tab 300 has the second length L2 after the electrode tab 300 is bent. Accordingly, a second gap D2 between the electrode assembly 200 and the insulating layer 500 may be reduced compared to FIG. 3. Accordingly, a region between the electrode assembly 200 and the case 100 may be reduced. In detail, a gap between the electrode assembly 200 and the inner surface of the accommodation part 110 may be reduced.

Accordingly, when the electrode assembly is accommodated in the accommodation part, the size of the case may be prevented from increasing due to the electrode tab. In other embodiments, the space occupied by the electrode tab in the case 100 may be reduced. Accordingly, the capacity of the secondary battery may be improved.

Further, the size of the case may be reduced by the thickness T of the electrode assembly. That is, since the electrode tab is bent by a plurality of bending portions, the height H of the electrode tab may be controlled to be less than or equal to the thickness of the electrode assembly. Accordingly, a compact secondary battery may be manufactured.

In addition, the first length L1 may be increased. Accordingly, the overlapping region of the electrode tab and the lead may be increased. Accordingly, the welding characteristics of the electrode tab and the lead may be improved. In addition, as the first length L1 increases, the electrode tab may be bent further. Accordingly, the size of the case may be prevented from increasing.

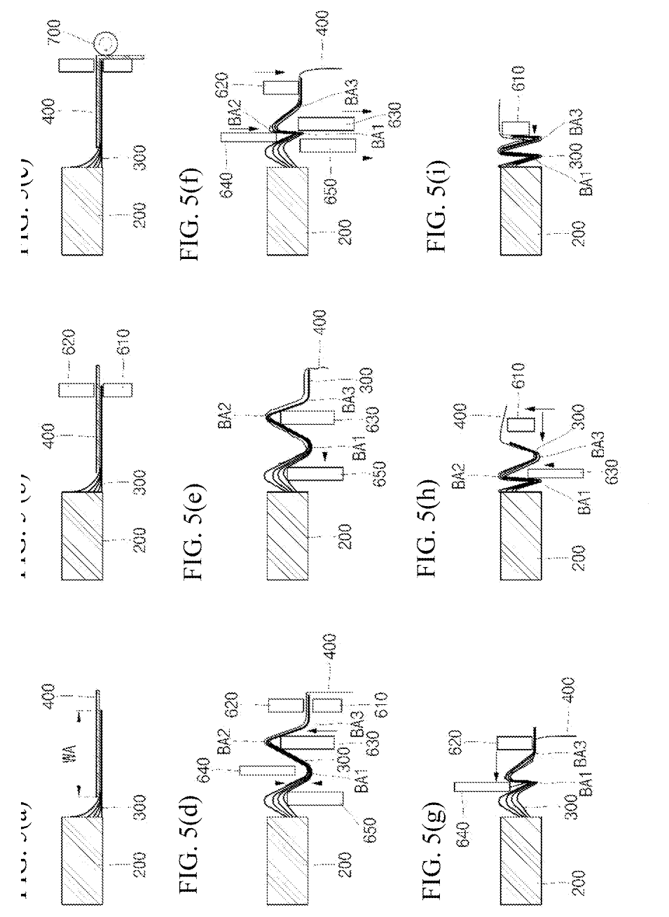

FIGS. 5(a) to 5(i) are views illustrating an example of a method for bending the electrode tab 300 and the lead 400. Referring to FIGS. 5(a) to 5(i), the electrode tab 300 and the lead 400 may be bent using a plurality of jigs and rollers.

Referring to FIG. 5(a), the electrode tab 300 and the lead 400 may be welded. Accordingly, the welding region WA may be formed.

Referring to FIG. 5(b), the electrode tab 300 and the lead 400 may be fixed by a first jig 610 and a second jig 620. The first jig 610 may be disposed under the electrode tab 300, and the second jig 620 may be disposed on the lead 400. The first jig 610 and the second jig 620 may be tab fixing jigs.

Referring to FIG. 5(c), the lead 400 may be bent. In detail, the lead 400 may be bent in one direction by the roller 700. At this time, the electrode tab 300 is not bent, and only the lead 400 may be bent. That is, the non-welded part of the lead 400 may be bent.

Referring to FIG. 5(d), the electrode tab 300 and the lead 400 may be bent. In detail, the welding region WA can be bent. In detail, the welding region WA may be bent by a third jig 630, a fourth jig 640, and a fifth jig 650. The third jig 630 may be disposed under the welding region, and the fourth jig 640 may be disposed on the welding region. In a state where the electrode tab 300 is fixed by the first jig 610 and the second jig 620, the third jig 630 may move upward, and the fourth jig 640 may move downward. Accordingly, the welding region may be bent. For example, the welding region may be bent in the first direction by the third jig 630 and in the second direction by the fourth jig 640. The fifth jig 650 may be disposed under the first region 1A. The fifth jig 650 may guide the position of the first region 1A when the third jig 630 and the fourth jig 640 move. Accordingly, the first bending region BA1, the second bending region BA2, and the third bending region BA3 may be formed.

Referring to FIG. 5 (e), the first jig (610) may be downward, and the second jig 620 and the fourth jig 640 may be moved upward. Next, the third jig 630 may be moved toward the fifth jig 650. Accordingly, the curvature of the first bending region BA1 may be controlled. That is, the curvature of the first bending region BA1 may be increased.

Referring to FIG. 5(f), the third jig 630 and the fifth jig 650 are moved downward. Next, the second jig 620 and the fourth jig 640 are moved downward.

Referring to FIG. 5(g), the second jig 620 may be moved toward the fourth jig 640. Accordingly, the curvature of the second bending region BA2 may be controlled. That is, the curvature of the second bending region BA2 may be increased.

Referring to FIG. 5(h), the first jig 610 and the third jig 630 move in an upward direction. Then, the first jig 610 may move toward the third jig 630. Accordingly, the curvature of the third bending region BA3 may be controlled. That is, the curvature of the third bending region BA3 may be increased.

Referring to FIG. 5(i), the first jig 610 may move toward the electrode assembly 200. Accordingly, the curvatures of the first bending region BA1, the second bending region BA2, and the third bending region BA3 may all be controlled. That is, the curvatures of the bending regions may be increased. Accordingly, the height of the electrode tab may be controlled to be less than or equal to the thickness of the electrode assembly.

As described above, the case 100 includes the region where the electrode tab 300 is disposed. An electrolyte is also disposed in the region where the electrode tab 300 is disposed. Therefore, a heat source transmitted from the outside may move to the electrolyte through the region where the electrode tab 300 is disposed. Accordingly, the electrolyte may be easily vaporized. Accordingly, the internal pressure and internal temperature may increase due to the gas generated from the electrolyte. Accordingly, a fire in the secondary battery may occur.

The embodiment can solve the problem by controlling the width of the electrode tab and disposing a heat dissipation layer on the electrode tab.

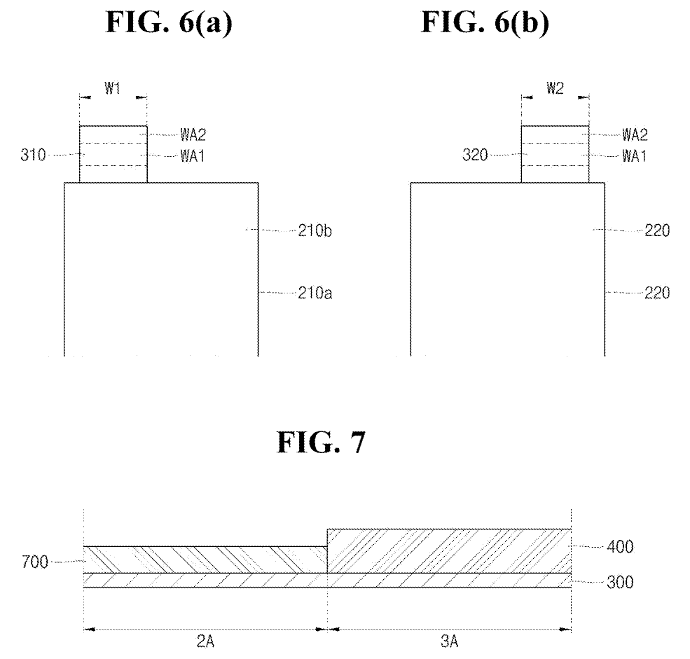

Hereinafter, the secondary battery according to the embodiment will be described in detail with reference to FIGS. 6a to 18.

Referring to FIG. 6(a), the first electrode 210 may include a first current collector 210a and a first active material layer 210b on the first current collector 210a. The first electrode tab 310 may be connected to the first electrode 210. For example, the first electrode tab 310 may be coupled to the first current collector 210a by welding. In other embodiments, the first electrode tab 310 may be formed integrally with the first current collector 210a. For example, the first current collector 210a may include the uncoated portion on where the first active material layer 210b is not disposed. The uncoated portion may be notched to have a first width W1. Accordingly, the first electrode tab 310 may be formed integrally with the first current collector 210a by the uncoated portion.

As shown in FIG. 6(b), the second electrode 220 may include a second current collector 220a and a second active material layer 220b on the second current collector 220a. The second electrode tab 320 may be connected to the second electrode 220. For example, the second electrode tab 320 may be coupled to the second current collector 220a by welding. In other embodiments, the second electrode tab 320 may be formed integrally with the second current collector 220a. For example, the second current collector 220a may include the uncoated portion where the second active material layer 220b is not disposed. The uncoated portion may be notched to have a second width W2. Accordingly, the second electrode tab 320 may be formed integrally with the second current collector 220a by the uncoated portion.

The secondary battery may include a plurality of first electrodes and a plurality of second electrodes. For example, the separator may be disposed between each first electrode and each second electrode, and the secondary battery may include a plurality of first electrodes and a plurality of second electrodes.

The plurality of first electrodes may be electrically connected by the first electrode tab 310. That is, the plurality of first electrode tabs may be coupled by welding. The plurality of second electrodes may be electrically connected by the second electrode tab 320. That is, a plurality of second electrode tabs may be coupled by welding.

The first electrode tab 310 and the second electrode tab 320 may each include a plurality of welding regions. For example, the electrode tab 300 may include a first welding region WA1 and a second welding region WA2. The first welding region WA1 may correspond to the second region 2A. The second welding region WA2 may correspond to the third region 3A. The region between the first welding region WA1 and the current collector may correspond to the first region first. See FIGS. 3 and 4.

Each of the electrode tabs may be coupled by the first welding region WA1. For example, a plurality of first electrode tabs may be coupled by the first welding region WA1. In addition, a plurality of second electrode tabs may be coupled by the first welding region WA1.

Each of the electrode tabs may be coupled to each lead by the second welding region WA2. For example, the first electrode tab 310 may be coupled to the first lead 410 by the second welding region WA2. The second electrode tab 320 may be coupled to the second lead 420 by the second welding region WA2.

The first width W1 and the second width W2 may have set sizes. For example, the first width W1 may be less than 50% of the width of the first current collector 210a. For example, the first width W1 may be 20% to 48%, 25% to 45%, or 30% to 42% of the width of the first current collector 210a. For example, the first width W1 may be 15 μm to 25 μm, 17 μm to 23 μm, or 19 μm to 21 μm.

The second width W2 may be less than 50% of the width of the second current collector 220a. For example, the second width W2 may be 20% to 48%, 25% to 45%, or 30% to 42% of the width of the second current collector 220a. For example, the second width W2 may be 15 μm to 25 μm, 17 μm to 23 μm, or 19 μm to 21 μm. The first width W1 and the second width W2 may have the same or different sizes within the above range.

The heat dissipation layer may be disposed on at least one of the first region, the first welding region, or the second welding region.

Accordingly, when the first electrode 210 and the second electrode 220 overlap, the first electrode 210 and the second electrode 220 may be prevented from contacting each other. In addition, the area of the heat dissipation layer disposed on the electrode tabs may be increased.

Referring to FIGS. 7 to 17, the heat dissipation layer 700 may be disposed on at least one surface of the electrode tab 300. The following description of the heat dissipation layer may be applied to at least one of the first electrode 210 and the second electrode 220.

Referring to FIGS. 7 to 9, the heat dissipation layer may be disposed on at least one surface of the electrode tab 300.

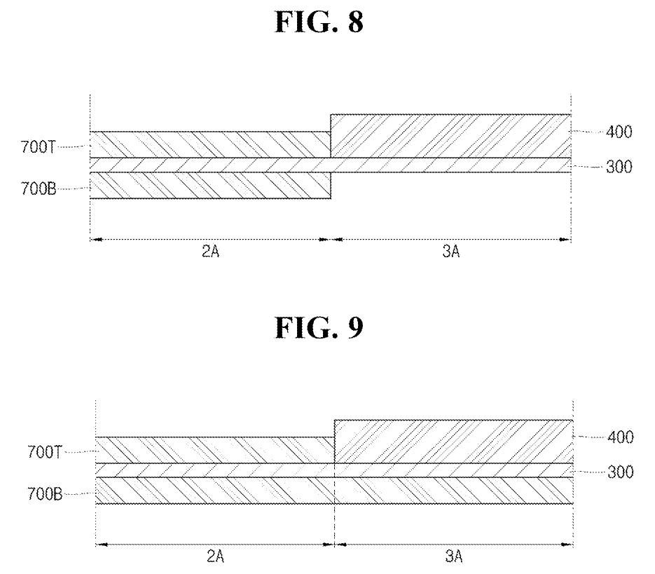

Referring to FIG. 7, the heat dissipation layer 700 may be disposed on one surface of the electrode tab 300. For example, the heat dissipation layer 700 may be disposed on the second region 2A. Referring to FIGS. 8 and 9, the heat dissipation layer may be disposed on both surfaces of the electrode tab 300. In detail, an upper heat dissipation layer 700T may be disposed on the upper surface of the electrode tab 300, and a lower heat dissipation layer 700B may be disposed on the lower surface of the electrode tab 300. The upper heat dissipation layer 700T and the lower heat dissipation layer 700B may have different lengths.

Referring to FIG. 8, the lengths of the upper heat dissipation layer 700T and the lower heat dissipation layer 700B may be the same or similar. For example, the upper heat dissipation layer 700T and the lower heat dissipation layer 700B may be disposed on the second region 2A.

Referring to FIG. 9, the lengths of the upper heat dissipation layer 700T and the lower heat dissipation layer 700B may be different. For example, the length of the lower heat dissipation layer 700B may be longer than the length of the upper heat dissipation layer 700T. For example, the upper heat dissipation layer 700T may be disposed on the second region 2A. In addition, the lower heat dissipation layer 700B may be disposed on the second region 2A and the third region 3A. The lower heat dissipation layer 700B may completely or partially overlap the lead 400.

Accordingly, since the area of the lower heat dissipation layer increases, the heat dissipation effect of the secondary battery may be improved. In addition, since the lower heat dissipation layer supports the third region, the third region 3A may be prevented from being bent in one direction by the lead 400.

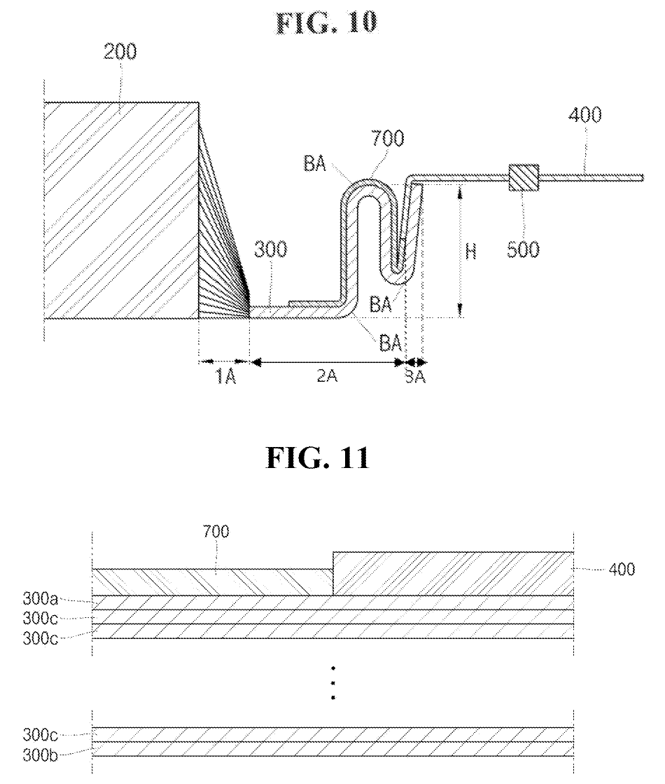

Referring to FIG. 10, the heat dissipation layer 700 may be disposed on the electrode tab 300. That is, the heat dissipation layer 700 may be disposed on the second region 2A. The heat dissipation layer 700 may be disposed on the non-bending region and the bending region. Since the heat dissipation layer 700 is disposed on the bending region, the area of the heat dissipation layer 700 may increase. The electrode tab may be formed with a set width. Therefore, the heat dissipation layer 700 may be disposed with a maximum area within a limited space.

The heat dissipation layer 700 may include a material having low thermal conductivity. The heat dissipation layer 700 may include a material having low electrical conductivity. For example, the heat dissipation layer 700 may include a resin material or a ceramic material. For example, the heat dissipation layer 700 may include polyimide (PI) or polyethylene terephthalate (PET). Accordingly, the heat dissipation characteristics of the heat dissipation layer 700 may be improved. In addition, the first electrode tab and the second electrode tab may be prevented from being short-circuited by the contact of the heat dissipation layers 700.

Accordingly, the heat source transmitted from the outside of the case may be absorbed by the heat dissipation layer. Accordingly, the heat source may be prevented from being directly transmitted to the electrolyte. Accordingly, the vaporization of the electrolyte may be delayed. Accordingly, the fire in the secondary battery may be prevented or reduced.

The heat dissipation layer 700 may have a set thickness. For example, the thickness of the heat dissipation layer 700 may be greater than or equal to the thickness of the current collector. The thickness of the heat dissipation layer 700 may be less than or equal to the thickness of the active material layer. In detail, the thickness of the heat dissipation layer may be greater than or equal to the thickness of the current collector and less than or equal to the thickness of the active material layer above.

When the thickness of the heat dissipation layer 700 is greater than the thickness of the active material layer, the overall thickness of the electrode tab may increase due to the heat dissipation layer. Accordingly, the angle of the bending portion of the electrode tab may be limited by the heat dissipation layer. Accordingly, the length of the electrode tab may be limited by the heat dissipation layer. Accordingly, the size of the case accommodating the electrode tab may increase.

Referring to FIGS. 11 to 14, the heat dissipation layer may be disposed on at least one electrode tab.

Referring to FIGS. 11 to 14, the secondary battery may include a plurality of electrode tabs. For example, the first electrode tab may include a first(a) electrode tab 300a, a first(b) electrode tab 300b, and a first(c) electrode tab 300c.

The first(a) electrode tab 300a may be an upper electrode tab. The first(b) electrode tab 300b may be a lower electrode tab. The first(c) electrode tab 300c may be a middle electrode tab. The first(c) electrode tab 300c may include a plurality of electrode tabs.

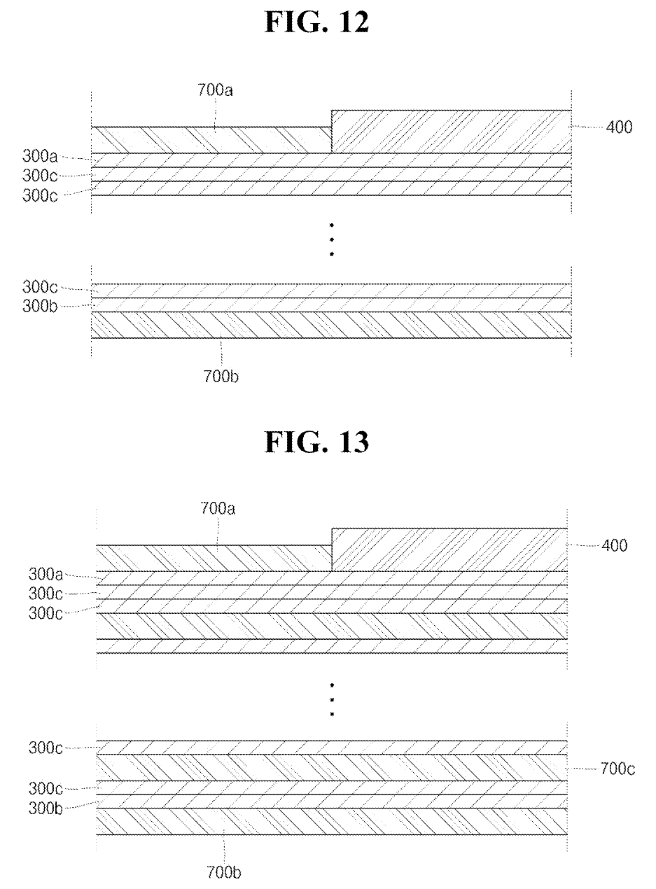

Referring to FIG. 11 and FIG. 12, the heat dissipation layer 700 may be disposed on at least one of the first(a) electrode tab 300a or the first(b) electrode tab 300b.

For example, referring to FIG. 11, the heat dissipation layer may be disposed on the first(a) electrode tab 300a. In detail, a first(a) heat dissipation layer 700a may be disposed on the first(a) electrode tab 300a. For example, the first(a) heat dissipation layer 700a may be disposed on at least one surface of the first(a) electrode tab 300a. The first(a) heat dissipation layer 700a may be disposed on the second region 2A.

Referring to FIG. 12, the heat dissipation layer may be disposed on the first(a) electrode tab 300a and the first(b) electrode tab 300b. In detail, the first(a) heat dissipation layer 700a may be disposed on the first(a) electrode tab 300a. For example, the first(a) heat dissipation layer 700a may be disposed on at least one surface of the first(a) electrode tab 300a.

In addition, the first(b) heat dissipation layer 700b may be disposed on the first(b) electrode tab 300b. For example, the first(b) heat dissipation layer 700b may be disposed on at least one surface of the first(b) electrode tab 300b. The first(b) heat dissipation layer 700b may be disposed on at least one of the second region 2A or the third region 3A. For example, the first(b) heat dissipation layer 700b may be disposed on the second region 2A and the third region 3A. The lengths of the first(a) heat dissipation layer 700a and the first(b) heat dissipation layer 700b may be different. For example, the length of the first(b) heat dissipation layer 700b may be longer than the length of the first(a) heat dissipation layer 700a.

The first(b) electrode tab 300b may be welded to adjacent other electrode tabs in a region other than the region where the first(b) heat dissipation layer 700b is disposed. For example, the first(a) heat dissipation layer 700b and the first welding region WA1 may be spaced apart from each other. Accordingly, the first(b) heat dissipation layer 700b may be prevented from melting during the welding process.

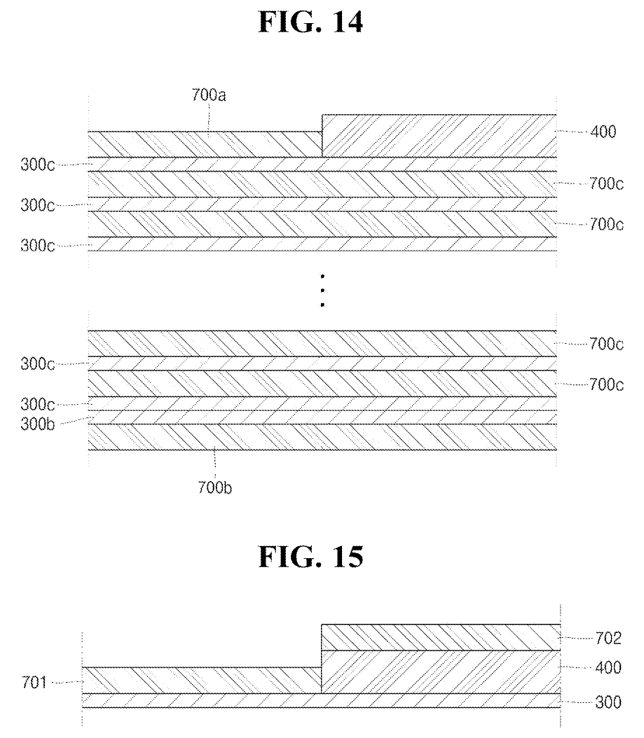

Referring to FIGS. 13 and 14, the heat dissipation layer 700 may be disposed on at least one of the first(a) electrode tab 300a, the first(b) electrode tab 300b, or the first(c) electrode tab 300c.

The heat dissipation layer may be disposed on the first(a) electrode tab 300a, the first(b) electrode tab 300b, and the first(c) electrode tab 300c. In detail, the first(a) heat dissipation layer 700a may be disposed on the first(a) electrode tab 300a. For example, the first(a) heat dissipation layer 700a may be disposed on at least one surface of the first(a) electrode tab 300a. In addition, the first(b) heat dissipation layer 700b may be disposed on the first(b) electrode tab 300b. For example, the first(b) heat dissipation layer 700b may be disposed on at least one surface of the first(b) electrode tab 300b. The first(b) heat dissipation layer 700b may be disposed on at least one of the second region 2A or the third region 3A. For example, the first(b) heat dissipation layer 700b may be disposed on the second region 2A and the third region 3A.

The first(c) heat dissipation layer 700c may be disposed on the first(c) electrode tab 300c. The first(c) heat dissipation layer 700c may be disposed on at least one of the first(c) electrode tabs among the plurality of first(c) electrode tabs.

The lengths of the first(a) heat dissipation layer 700a, the first(b) heat dissipation layer 700b, and the first(c) heat dissipation layer 700c may be different. For example, the lengths of the first(b) heat dissipation layer 700b and the first(c) heat dissipation layer 700c may be longer than the length of the first(a) heat dissipation layer 700a.

In addition, the thicknesses of the first(a) heat dissipation layer 700a, the first(b) heat dissipation layer 700b, and the first(c) heat dissipation layer 700c may be different. For example, the thickness of the first(c) heat dissipation layer 700c may be smaller (e.g., less) than the thicknesses of the first(a) heat dissipation layer 700a and the first(b) heat dissipation layer 700b. Accordingly, the heat dissipation characteristics may be improved while preventing the thickness of the electrode tab from increasing due to the first(c) heat dissipation layer 700c.

Referring to FIG. 13, the heat dissipation layer may be disposed on some of the plurality of third electrode tabs. For example, the first(c) electrode tabs on which the heat dissipation layer is disposed and the first(c) electrode tabs on which the heat dissipation layer is not disposed may be disposed alternately. Referring to FIG. 14, the heat dissipation layer may be disposed on all of the plurality of first(c) electrode tabs.

The first(c) heat dissipation layer 700c may be disposed on at least one surface of the first(c) electrode tab 300c. The first(c) heat dissipation layer 700c may be disposed on at least one of the second region 2A or the third region 3A. For example, the first(c) heat dissipation layer 700c may be disposed on the second region 2A and the third region 3A.

The heat dissipation layer may be disposed on a plurality of electrode tabs. Accordingly, the area of the heat dissipation layer may increase. Accordingly, the heat dissipation characteristics of the secondary battery may be improved. In addition, when an external heat source is transmitted to the electrode tabs, the electrode tabs may be similarly stretched or contracted. In detail, since the thermal conductivities of the electrode tabs become similar, the electrode tabs may be similarly deformed by the heat source. Accordingly, the welded electrode tabs may be prevented from being separated. In addition, the occurrence of cracks in the electrode tabs disposed in the bending portion may be prevented.

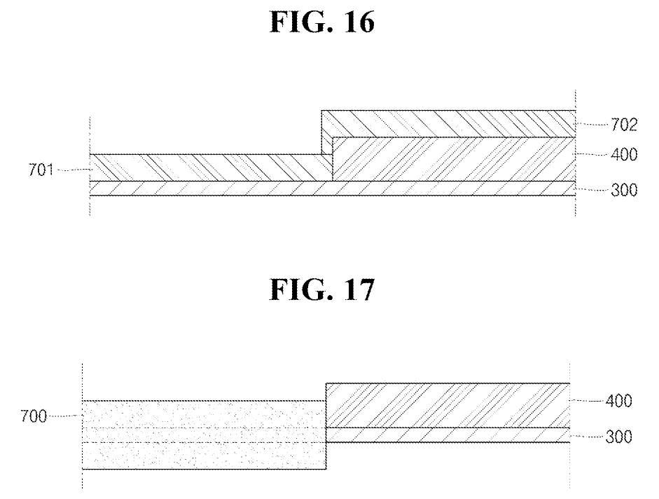

Referring to FIGS. 15 and 16, the heat dissipation layer may also be disposed on the lead 400. For example, the heat dissipation layer may include a heat dissipation layer 701 on the electrode tab 300 and a heat dissipation layer 702 on the lead 400. Referring to FIG. 14, the heat dissipation layers 701 and 702 may be spaced apart from each other. That is, the heat dissipation layers 701 and 702 may not contact each other. Referring to FIG. 15, the heat dissipation layers 701 and 702 may be connected. That is, the heat dissipation layers 701 and 702 may contact each other (see FIG. 16).

Accordingly, the area on which the heat dissipation layer is disposed may increase. Accordingly, the reliability of the secondary battery may be improved. In addition, the heat dissipation layer may be disposed on the welding region of the electrode tab and the lead. Accordingly, the welding region may be protected by the heat dissipation layer. Accordingly, damage to the welding region may be prevented.

Referring to FIG. 17, the heat dissipation layer 700 may be disposed on plurality of surfaces of the electrode tab 300. For example, the heat dissipation layer 700 may be disposed to surround (e.g., a portion of) the electrode tab 300.

Therefore, the heat dissipation layer 700 may also be disposed on the side surface of the electrode tab 300. Therefore, even if the position of the electrode tab is moved due to an external impact, the first electrode tab and the second electrode tab may be insulated by the heat dissipation layer. Therefore, the reliability of the secondary battery may be improved.

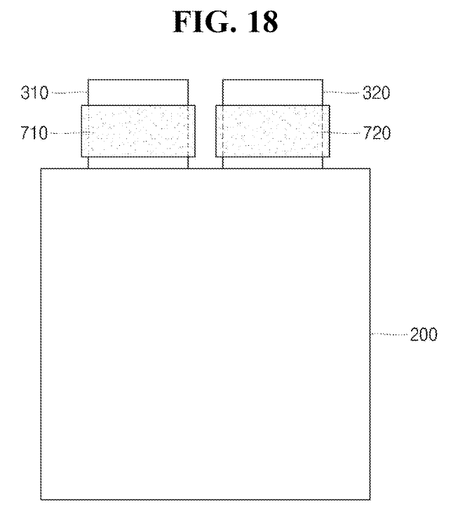

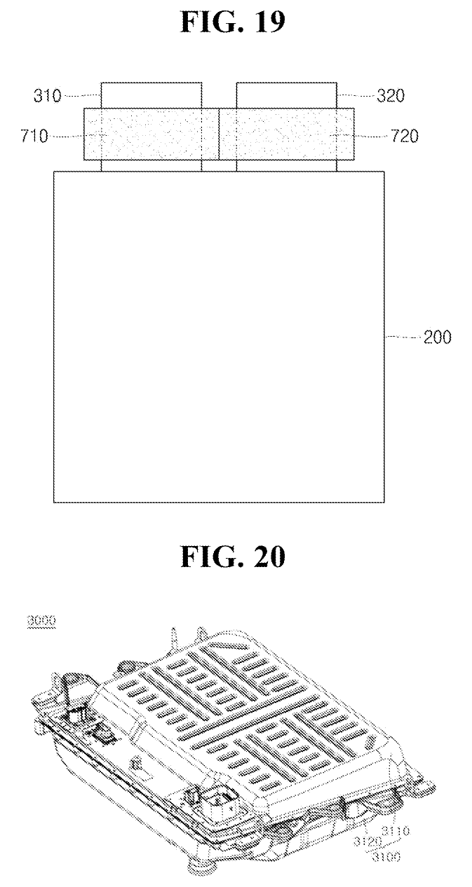

Referring to FIGS. 18 and 19, the heat dissipation layer may include a first heat dissipation layer 710 and a second heat dissipation layer 720. The first heat dissipation layer 710 is disposed on the first electrode tab 310. The first heat dissipation layer 710 may be disposed to surround the first electrode tab 310. The second heat dissipation layer 720 may be disposed on the second electrode tab 320. The second heat dissipation layer 720 may be disposed to surround the second electrode tab 320.

Referring to FIG. 18, the first heat dissipation layer 710 and the second heat dissipation layer 720 may be spaced apart from each other. That is, the first heat dissipation layer 710 and the second heat dissipation layer 720 may not contact each other. Accordingly, the heat dissipation layer may prevent abrasion due to contact. Therefore, the heat dissipation layer may be prevented from being peeled off from the electrode tab.

Referring to FIG. 19, the first heat dissipation layer 710 and the second heat dissipation layer 720 may be in contact. Accordingly, the first electrode tab 310 and the second electrode tab 320 may not be in contact with each other due to the heat dissipation layers 710 and 720. In addition, the electrode tabs may be fixed in position by the contact of the heat dissipation layers. That is, the electrode tabs may prevent the electrode tabs from moving in a direction in which the electrode tabs become closer due to an external impact. Accordingly, the heat dissipation layers 710 and 720 may be an insulating member of the electrode tabs. Accordingly, the reliability of the secondary battery may be improved.

The secondary battery according to one or more embodiments includes the heat dissipation layer on the electrode tab.

The electrode tab includes at least two or more bending regions. Accordingly, the length of the electrode tab may increase. In addition, the welding area of the electrode tab and the lead may be increased. In addition, the space where the electrode tab is disposed inside the case may be reduced. Therefore, the reliability and capacity of the secondary battery may be improved.

The electrode tab may have a set width. In detail, the electrode tab may be 20% to 48% of the width of the current collector. Thus, the heat dissipation layer is disposed in a plurality of bending regions and may be disposed with a wide width. Therefore, the area of the heat dissipation layer disposed on the electrode tab may be increased.

Thus, the heat dissipation characteristic may be improved in the space between the electrode assembly and the accommodation part. Accordingly, the time when the heat source moves to the electrolyte is delayed, so that a fire of the secondary battery may be prevented.

In addition, the heat dissipation layer may be disposed in a plurality of bending regions. Therefore, the electrode tab may be protected. Thus, cracks may be prevented from occurring in the bending region of the electrode tab.

Therefore, the secondary battery according to the embodiment may have improved safety, reliability, and capacity.

The secondary battery described above may form a battery module. For example, the battery module may include a plurality of secondary batteries. The plurality of secondary batteries may be connected to each other in series, parallel, or series/parallel by a bus bar.

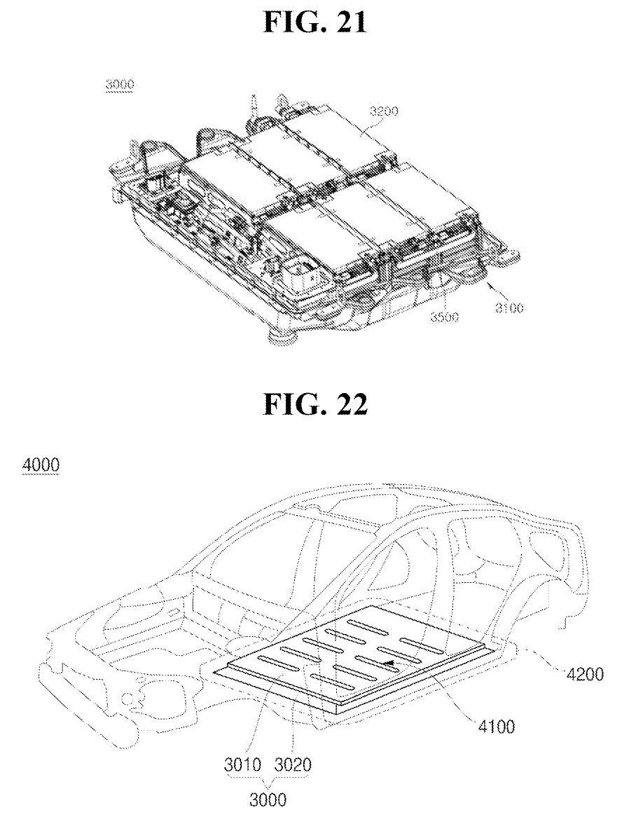

FIGS. 20 and 21 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 22, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

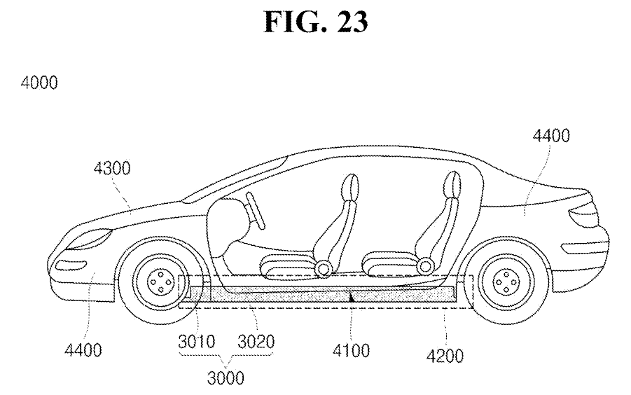

In FIG. 23, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a case including an accommodation part and a cap part;
an electrode assembly having a current collector in the accommodation part;
an electrode tab in the accommodation part, the electrode tab being connected to the electrode assembly;
a lead connected to the electrode tab; and
a heat dissipation layer on the electrode tab,
the electrode tab including at least two bending regions and a non-bending region,
the heat dissipation layer on the at least two bending regions and the non-bending region, and
a width of the electrode tab is 25% to 45% of a width of the current collector of the electrode assembly.

2. The secondary battery as claimed in claim 1, wherein:
the electrode assembly comprises a plurality of first electrodes, a plurality of second electrodes, and a separator between each of the plurality of first electrodes and each of the plurality of second electrodes, and
the plurality of first electrodes and the plurality of second electrodes each comprises the current collector and an active material layer on the current collector.

3. The secondary battery as claimed in claim 2, wherein:
each of the plurality of first electrodes comprises a first current collector and a first active material layer on the first current collector,
each of the plurality of second electrodes comprises a second current collector and a second active material layer on the second current collector,
the electrode tab comprises a first electrode tab connected to the first current collector and a second electrode tab connected to the second current collector, and
the heat dissipation layer is on at least one of the first electrode tab and the second electrode tab.

4. The secondary battery as claimed in claim 1, wherein a thickness of the heat dissipation layer is greater than or equal to a thickness of the current collector and equal to or less than a thickness of an active material layer.

5. The secondary battery as claimed in claim 1, wherein:
the electrode tab comprises a first region, a second region, and a third region,
the first region includes adjacent other electrode tabs that are separated,
the second region includes adjacent other electrode tabs that are coupled,
the third region is coupled with the lead, and
the at least two bending regions are on the second region.

6. The secondary battery as claimed in claim 5, wherein the heat dissipation layer is on at least one of the second region and the third region.

7. The secondary battery as claimed in claim 6, wherein the heat dissipation layer is on at least one surface of the electrode tab.

8. The secondary battery as claimed in claim 7, wherein the heat dissipation layer comprises an upper heat dissipation layer on an upper surface of the electrode tab and a lower heat dissipation layer on a lower surface of the electrode tab, and
wherein a length of the upper heat dissipation layer and a length of the lower heat dissipation layer are different.

9. The secondary battery as claimed in claim 8, wherein:
the lead is on the upper surface of the electrode tab,
the length of the lower heat dissipation layer is longer than the length of the upper heat dissipation layer, and
the lower heat dissipation layer and the lead overlap.

10. The secondary battery as claimed in claim 6, wherein:
the electrode tab comprises a first(a) electrode tab, a first(b) electrode tab, and a first(c) electrode tab,
the first(a) electrode tab is an upper electrode tab,
the first(b) electrode tab is a lower electrode tab,
the first(c) electrode tab is a middle electrode tab, and
the heat dissipation layer is on at least one of the first(a) electrode tab, the first(b) electrode tab, and the first(c) electrode tab.

11. The secondary battery as claimed in claim 10, wherein the heat dissipation layer is on at least one of the first(a) electrode tab and the first(b) electrode tab.

12. The secondary battery as claimed in claim 11, wherein the heat dissipation layer comprises a first(a) heat dissipation layer on the first(a) electrode tab and a first(b) heat dissipation layer on the first(b) electrode tab, and
wherein a length of the first(a) heat dissipation layer and a length of the first(b) heat dissipation layer are different.

13. The secondary battery as claimed in claim 11, wherein the heat dissipation layer comprises:
a first(a) heat dissipation layer on the first(a) electrode tab;
a first(b) heat dissipation layer on the first(b) electrode tab; and
a first(c) heat dissipation layer on the first(c) electrode tab,
wherein a length of the first(a) heat dissipation layer is different from a length of each of the first(b) heat dissipation layer and the first(c) heat dissipation layer.

14. The secondary battery as claimed in claim 13, wherein a thickness of the first(c) heat dissipation layer is less than a thickness of the first(a) heat dissipation layer and a thickness of the first(b) heat dissipation layer.

15. The secondary battery as claimed in claim 13, wherein:
the first(c) electrode tab comprises a plurality of electrode tabs, and
the first(c) heat dissipation layer is on at least one of the plurality of electrode tabs.

16. The secondary battery as claimed in claim 1, wherein the heat dissipation layer comprises the heat dissipation layer on the electrode tab and the heat dissipation layer on the lead.

17. The secondary battery as claimed in claim 1, wherein the heat dissipation layer surrounds the electrode tab.

18. The secondary battery as claimed in claim 3, wherein the heat dissipation layer comprises a first heat dissipation layer surrounding the first electrode tab and a second heat dissipation layer surrounding a second electrode tab.

19. The secondary battery as claimed in claim 18, wherein the first heat dissipation layer and the second heat dissipation layer are spaced apart from each other.

20. The secondary battery as claimed in claim 18, wherein the first heat dissipation layer and the second heat dissipation layer are in contact.
